(19) United States
(12) Patent Application Publication
(10) Pub. No.: US 2014/0227095 A1
(43) Pub. Date: Aug. 14, 2014

(54) PIVOTAL JET WIND TURBINE

(71) Applicant: Leonid Minutin, Ariel (IL)

(72) Inventor: Leonid Minutin, Ariel (IL)

(21) Appl. No.: 14/345,952

(22) PCT Filed: Aug. 30, 2012
(86) PCT No.: PCT/IL2012/050338

§ 371 Date: Mar. 20, 2014

(30) Foreign Application Priority Data
Sep. 21, 2011 (IL) 215281

(51) Int. Cl. F03D 1/06; F03D 7/04; F03D 7/02

(52) U.S. Cl. CPC F03D 1/0625; F03D 7/0204; F03D 7/04
USPC 416/9

(57) ABSTRACT

Pivotal jet wind turbine relates to clean energy field. It has a rim based rotor's structure. The rotor has plurality of outer-blades and plurality of inner-blades attached to the rotating rim. The roller based components suspend the rotor and transmit the rotational energy to generator(s). The central, pivotal part of the rotor is in full free from any mechanical or aerodynamic components or parts. This open zone constitutes a giant nozzle, producing an air-jet increasing the turbine's efficiency.

### FIELD OF THE INVENTION

The present invention relates to wind turbines. More particularly, the invention relates to the wind turbine having a plurality of outer-blades and a plurality of inner-blades attached to the rotating rim.

### BACKGROUND OF THE INVENTION

There is a wide spectrum of the wind-to-energy conversing turbines. The main element defining the turbine's type is the rotor's shape.

In U.S. Pat. No. 6,951,443 entitled “Wind turbine ring/shroud drive system” the wind turbine of three-blade rotor is disclosed. This rotor is based on ring or shroud structure for reducing blade root bending moments. The blades of this rotor is very long that brings the common turbine's problem decreasing its efficiency—big linear speed difference between root vs tip parts of the blade. The rotor is carried by the central hub and by two struts. The hub and the struts are mounted into/onto nacelle, i.e. all stresses and forces from the rotor hub and the struts are finally concentrating on/in the nacelle. Thus, the element (nacelle) carrying the rotor does not get any decreasing in stresses producing by the rotor. The central pivotal area of the rotor is being not free for the air flows, its square is taken by struts, interior blades, nacelle itself. As in each common turbines this pivotal rotor's area does not takes any significant part in the energy producing since the low rotating moments (i.e. the distance to the revolution axis). Therefore, the pivotal rotor's part brings a significant drag forces without to generate an energy.

In U.S. Pat. No. 7,323,792 entitled “Wind turbine” the wind turbine with foldable blades attached to the rim is disclosed. Here the hub also carries all stresses from the rotor, the central axial part of the rotor is not free for the air flows.

In U.S. Pat. No. 7,550,864 entitled “Wind turbine” the wind turbine with a plurality of radial blades attached to the ring-shaped aerofoil diffuser is disclosed. In this turbine the ring-diffuser is used to reduce acoustic emission. The other configuration of this turbine remained without changes—high difference in tip-root blade speeds, at a very high degree filled the pivotal rotor's area, hub carries all stresses.

In U.S. Pat. No. 7,775,760 entitled “Turbine wheel” the turbine wheel comprising a peripheral rim, series of spokes, plurality of airfoil flexible blades is disclosed. In this turbine the ring-diffuser is used to reduce acoustic outer rim attached to the blades' tip is used. Here the rotor also is carries by the hub, the blades have non-defined shapes decreasing aerodynamic efficiency of the rotor. The central part of the rotor is taken by plurality of non-visible spokes being danger for the birds.

In U.S. Pat. No. 7,964,978 entitled “Wind turbine having a blade ring using magnetic levitation” the wind turbine with a ring to which blades are attached. The ring holds the blades and provides the rotor revolutions into a stator/guide track. The rotor is located and supported into said guide track either by mechanical means or electrical means (by magnetic field) for reducing friction between rotor and stator. This rotor has a very filled (by blades, hub, external from supports) central part, this prevents the free air flow at that area. The blades have a high difference between tip/root linear speeds. Both rotor and stator have ring structures, therefore such configuration will be high level weight at large enough embodiments. This will be obstacle to build high power big turbines. Two ring structures will be doubly expensive through installation.

In U.S. Pat. No. 7,980,811 entitled “Turbine with mixers and ejectors” the wind turbine with an aerodynamically contoured shroud with inlet, ring of stator vanes, ring of rotating blades, mixer/ejector pump to increase the flow volume through the turbine while rapidly mixing the low energy exit flow with high energy bypass fluid flow. Here the diffuser related effects are used—the increasing the flow velocity at the output of nozzle like structure. The energy of increased speed flow is used to draw the low speed air flows occurred after the rotor's blades. But here as the air source for the ejectors (diffusers) the outer wind streams are used. The wind flows entry into turbine meet the high resistance in pivotal area of the rotor where the hub and the blades' roots are presenting. That brings to decreasing the turbine's efficiency. The aerodynamic flows' distribution is formed/forced by the significant constructive elements—the mixer/ejector's shrouds. These elements have significant drags sharply reducing aerodynamic effectiveness, take large space, have high weight and, finally, limit the possible embodiments of such type turbines by small ones.

The present invention has been made with the aim of solving the noted above and additional problems, and it is an object of the present invention to provide an effective aerodynamics of the rotor increasing the wind energy captured by the turbine.

Another object of the present invention is to decrease the speed differences between tip and root parts of the blades, decrease audible and infra-sound noise emission.

Still another object of the present invention is to provide the stability, reliability of turbine performance, decrease the stresses in the turbine elements, provide flexible adapting the turbine to the current wind parameters, provide optimal work parameters for the electric generation.

Yet another object of the present invention is to provide a universal configuration being applicable for all diapason of generated power—from small wind turbines 1 KW till giant wind turbines 100 MW.

A further object of the present invention is to provide the safety for birds.

### SUMMARY OF THE INVENTION

The present invention provides a wind turbine with two (or more) pluralities of the blades attached to the rim. The configuration of this turbine is applicable both for upwind and downwind turbines types. The blades configured to provide in the rotor a pivotal diffuser. The air streams passing through the diffuser indirectly enhance the aerodynamics of the rotor and, accordingly, increase efficiency of the present wind turbine.

The present turbine has a tower comprising stationary standing- and turning yaw-portions. The standing-portion is established onto land, sea bottom, floating platform, etc. The yaw-portion is jointed to the top part of the standing-portion through the turning yaw-mechanism.

The yaw-portion carries the rotor. I.e. the rotor itself does not perform yaw turnings. It is placed definite onto and relative to the yaw-portion. The absence of necessary of yaw related turnings allows to not use hub, and hub related (more particular, nacelle related) yaw-gear. In the common turbines all being very hard loads and stresses are concentrating in these elements, the carrying elements have a small bases providing large bending moments, loads, etc. In the present turbine such extremely loaded points and in-one-point-concentrated forces are absent, the supporting bases are very long and reliable.

Since through the yaw turning the arms with the rotor always are being one-way oriented relative wind direction it is possible to use in the present turbine the unidirectional aerofoil shape of the arms. This drastic decreases the drag forces, enhances the aerodynamic of the rotor, and as result the efficiency of the present turbine is grown. Also aerofoil shape of the arms allows to use the present turbine with high effectiveness both as upwind and downwind mode turbine—the arms even located in-front of the rotor bring a very low vortices or other negative things to the air streams.

In the preferred embodiment the yaw-portion has two arms constituting a near to V-shape construction. The arms and the root-part of the yaw-portion are carrying four roller based components of rotor suspend set (RS-SET). The roller components are in mechanical rotatable contact with the rim of the rotor. They support the rim at four points and are defining the rim's (and accordingly the rotor's) suspension relatively yaw-portion of the wind turbine. I.e. the rotor itself does not perform any yaw turning—the yaw to wind related orientation is performing the yaw-mechanism.

The rim and two lowest roller components of RS-SET constitute at single-stair gear with high enough rotation transmission ratio. That allows to build the present turbine without conventional gear-boxes (being almost “standard” part of big wind turbines, bringing hard weight, sound noise and energy losses), but get a suitable revolution speed to spin the generator(s).

Two upper roller based components of RS-SET mounted onto top parts of the arms do not carry significant loads, their main function is to fix the rotor relative the yaw-portion.

The rotor has two blades' assembles attached to the rim. The six inner-blades are attached so to be inward radial oriented to the rim's center. The twelve upper-blades are attached so to be outward radial oriented to the rim's periphery. The number of outer-blades is two times more than number of the inner-blades. That allows to the present turbine to much more effective capture the wind flows at the periphery of the rotor (where in the common turbines there are very big distances between the blades; for example, in the three-blade turbine with rotor diameter 100 m the distances between the blade tips will be more than 100 m and part of wind streams merely passes between the blades without to interact with them). Each blade has a rotating supporting post to which the blade is attached and which provides the angle-of-attack regulating. The multiple blade configuration of the rotor is well visible to the birds which may lightly overcome the rotor through flight. In addition, the rotor is rotating at very low rotational speed—this is possible since very high rotation transfer ratio of the gear rim-to-roller. Low rotational speed provides decreasing of stresses and loads, decreases noise emission, allows to use more effective angles-of-attack for the blades, allows to increase the square of the blades. As result, we get increased power of the rotor. Also, the low rotational speed additionally decreases the danger for the birds.

The ensemble of six inner-blades provides the free-to-pass area in the pivotal zone of the rotor. Of course the air streams of this area do not interact with the blades and do not bring energy to the rotor at direct mode. But these streams bring additional energy by indirect mode.

The wind flows through interacting with the rotor produce an increased pressure in front of the rotor. Part of the air from this zone passes through the free pivotal zone and goes out with risen speed—the free pivotal zone works as giant diffuser producing a giant air jet. Outgoing high speed air flows (jet) are mixing with low speed air flows passed the inner-blades and are dragging these low speed flows from the rotor forming the pressure decreasing (and, accordingly growth the pressure difference between air before and after the rotor's disk). This increased pressure difference provides more active air flow passing through the rotor, and accordingly elevates the rotor efficiency. Therefore, the jet produced by the pivotal zone in the present turbine works at indirect mode and not being lost—it brings additional power.

Two lowest roller based components of RS-SET in the discussed preferred embodiment capture the rotating from the rim and through a rotation transfer means (RTM) transfer the rotation to one or two generators. The generators are placed into the standing-portion at very low height in the closed space. That decreases the load moments, provides additional protection from environmental conditions and protection from noise emission.

In the first embodiment the rotor has inner-rim. One of the variants is that the inner-rim is attached to the tips of the inner-blades. Other variant is that the turbine has three blades' ensembles—one of outer-blades and two of inner-blades. One of ensemble of inner-blades has three blades with long enough length (equal roughly radius of the rim minus radius of the inner-rim). To the tips of these blades the inner-rim is attached. Another ensemble of inner-blades contains three more short blades. They extend from the rim inward to the rim's center, but do not reach the inner-rim. Such configuration provides optimal distances between the blades through all rotor's square both near to the rotor's axis as well as at periphery of the rotor. The twelve outer-blades are allocated analogously to noted above preferable embodiment. The inner-rim is used to increase the diffuser effect for the pivotal zone air streams.

In another embodiments the arms may have different form. For example, it may be used single arc- or pear-like shape arm carrying one or more roller components of the RS-SET.

In the still another embodiments the present turbine comprise several (one, two, three, etc.) generators preferably having different power. Through operating accordingly to different wind conditions the roller based components of RS-SET and the RTM transfer the rotation energy to any certain ensemble of generators (usually being according in power level with the wind power factor). That allows at the certain moment to use only certain generators at optimal regimes and disconnect generators of exceeding power.

In the yet another embodiment the rotor's suspension is provided by magnet based components of the RS-SET. That significantly decreases the friction in the present turbine.

In alternate embodiments the present turbine may be configured to operate in upwind or downwind mode.

In small embodiments the present turbine may be equipped with vane providing yaw orientation of the yaw-portion relative wind direction.

### BRIEF DESCRIPTION OF THE DRAWINGS

FIG. 1 illustrates the preferable embodiment of the present wind turbine.

FIG. 2 illustrates the same preferable embodiment of the present wind turbine at the perspective view to provide clear understanding the turbine's configuration.

FIG. 3 depicts the perspective view of the tower.

FIG. 4 shows the vertical cut of the wind turbine and possible location of some roller based components of the rotor suspend set (RS-SET), the rotation transfer means (RTM), and the generator.

FIG. 5 depicts one of possible variants of the rim's suspension at the top part of the arm on the roller based component of the RS-SET.

FIGS. 6A and 6B illustrate one of possible embodiment of the wind turbine with pear-like shape of arm. FIG. 6A depicts the tower of the wind turbine comprising the standing-portion and the yaw-portion equipped with four roller based components of the RS-SET. FIG. 6B depicts the fully assembled wind turbine having pear-like arm's shape—the tower (with said pear-like shape arm) and the rotor suspended by said four roller based components of the RS-SET.

FIG. 7 depicts one of possible variants of the rotor's configuration—the rotor with central additional rim.

FIG. 8 depicts another possible variant of the rotor's configuration—the rotor with two ensembles of the inner-blades, where blades from one ensemble have the length substantially equal to the radius of the rim and attached one with another through a central spindle.

### DETAILED DESCRIPTION OF THE INVENTION

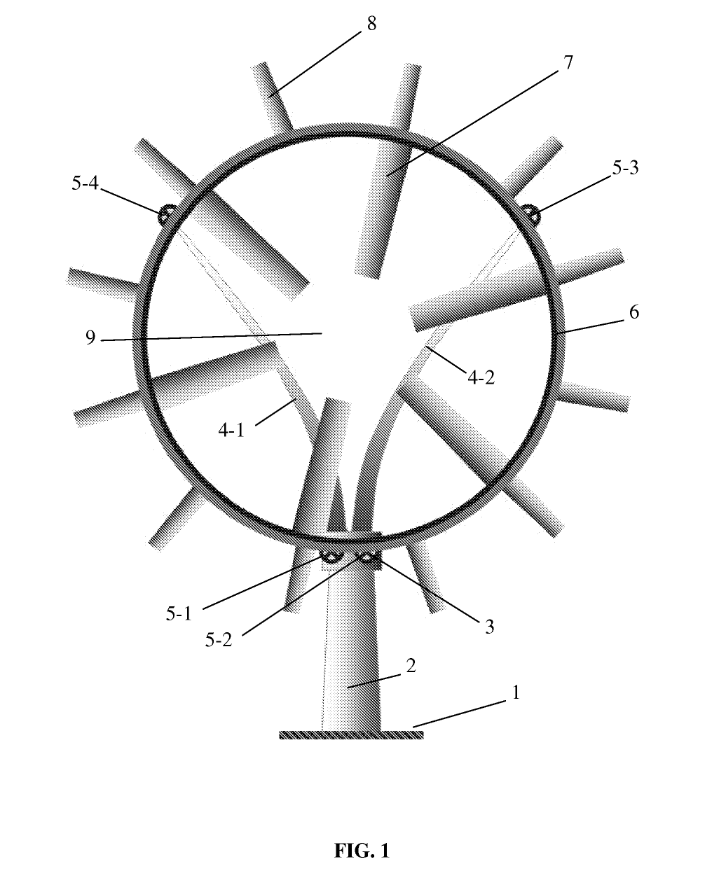

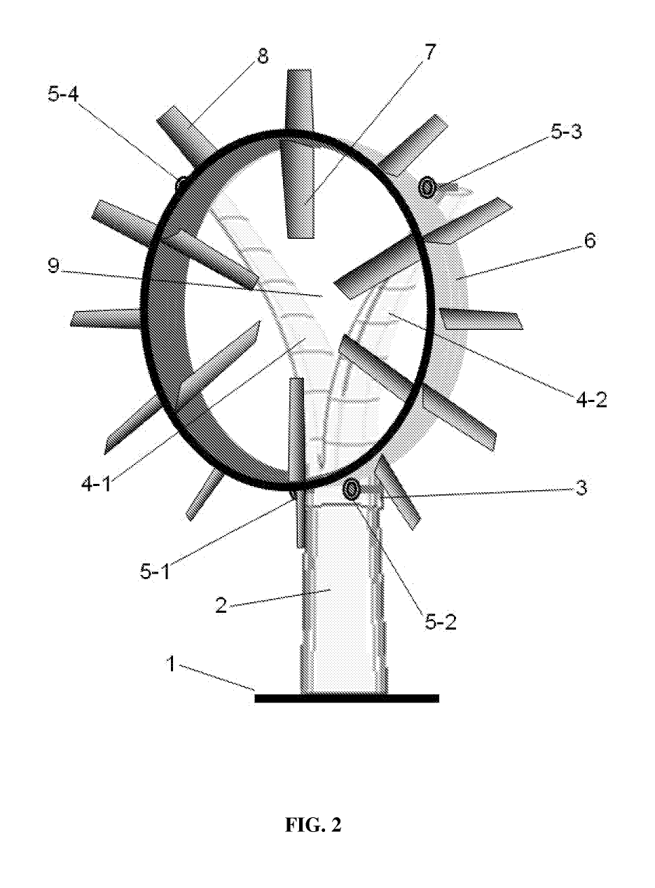

FIG. 1 illustrates the preferable embodiment of the present wind turbine. FIG. 2 illustrates the preferable embodiment of the present wind turbine at the perspective view to provide clear understanding the turbine's configuration. Both FIG. 1 and FIG. 2 represent the same turbine and have the same components' numbering. At the FIG. 1 and FIG. 2 they are shown: ground 1 onto which the wind turbine is established by use a foundation (it is not visible and therefore not signed individually); standing-portion 2 being fixedly vertically mounted onto the ground 1; root-part 3 of yaw-portion mounted onto the top of the standing-portion 2, the root-part 3 of the yaw-portion is jointed with the standing-portion 2 through the yaw-mechanism (it is located into the yaw-portion and is not visible and not signed); onto the root-part 3 two arms 4-1 and 4-2 are mounted, the arm 4-1 is substantially extending upward and left-ward, the arm 4-2 is substantially extending upward and right-ward from the root-part 3; the root-part 3 and the arms 4-1 and 4-2 constitute the yaw-portion (not singed individually) of the present wind turbine; onto the root-part 3 two roller based components of the rotor suspend set (RS-SET) are mounted—left component of the RS-SET 5-1 and right component of the RS-SET 5-2; these RS-SET's components 5-1 and 5-2 are mechanically carrying the most weight of the rim 6 and attached to the rim 6 ensemble of inner-blades 7 and ensemble of the outer-blades 8; the rim 6, the inner-blades 7 and the outer-blades 8 constitute the rotor (not signed individually) of the present wind turbine; at the top parts of the arms 4-1 and 4-2 they are mounted two additional roller based components of the RS-SET—5-4 and 5-3 accordingly, they do not carry a significant weight or loads but they provide a definite suspension of the rotor relative the yaw-portion; at the center of the rotor there is a free pivotal zone 9 constituting a large diffuser.

The components 5-1, . . . 5-4 of the RS-SET provide the rotor the rotatable and definite suspension relative the yaw-portion. The rotor does not perform any yaw related turnings through guiding the wind direction. This function performs the yaw-portion. Therefore, the yaw-portion always has a unidirectional orientation relative the wind. That allows to build the yaw-portion, generally the arms (in the discussed case of the preferable embodiment—the arms 4-1 and 4-2), with streamlined aerofoil shape through the wind line passing. That at a significant degree decreases at drag forces of the present wind turbine's tower and decreases the load moments at yaw-portion, yaw-mechanism, standing-portion, foundation, etc. Also this allows to use the present turbine both in upwind as well as in downwind mode operating.

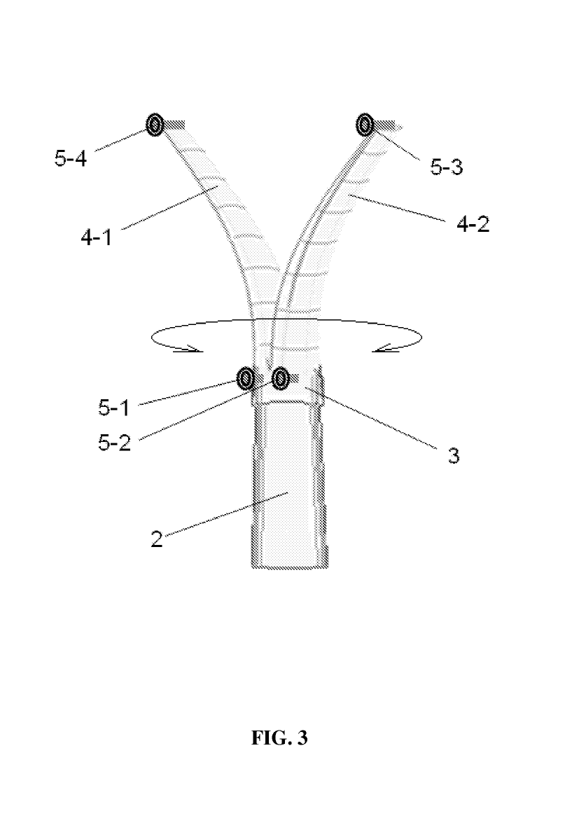

FIG. 3 illustrates said streamlined aerofoil shape of the arms 4-1 and 4-2. The round pointer illustrates the turning of the yaw-portion through the wind direction guidance. The plane passing substantially vertically through the arms 4-1 and 4-2 and the standing-portion 2 we name “sagittal plane”. The vertical plane being perpendicular to the sagittal plane and parallel to the wind direction we name “longitudinal plane”. The rotor and, accordingly, its swept area are substantially located at the sagittal plane of the present turbine to capture maximal possible air flow. The RS-SET 5-1, . . . 5-4 is mounted onto the yaw-portion and, therefore is turning together with it. I.e., the suspension of the rotor is performed by the four points located at a significant distances one from another providing a large bases. Such bases drastic decrease the yaw related moments and loads appeared in the rotor and in the tower's elements.

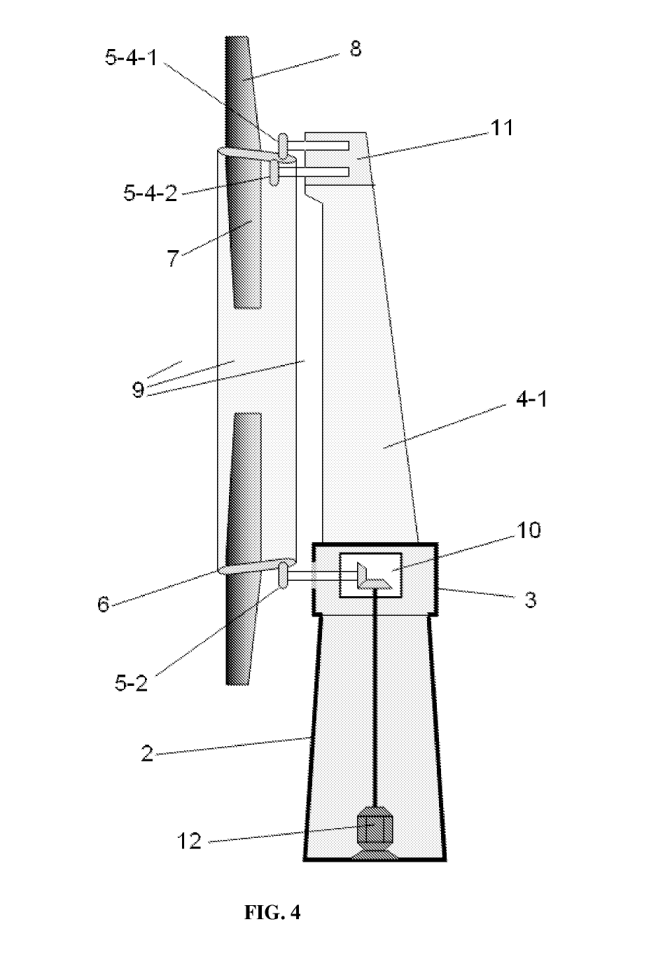

FIG. 4 shows more particular one of possible schemes of the rotor suspension. The lowest roller based component of the RS-SET 5-2 performs generally the supporting function. It supports the rotor through supporting the rim 6. In the component 5-2 of the RS-SET it may be used one-roller scheme where the roller is located from below the rim 6. Through the supporting functions the component 5-2 of the RS-SET is rotating in accordance with the rim 6 rotation (for this a special path in the rim 6 may be provided, this path may be toothed as well as the roller 5-2 too). This rotation is sent to the rotation transfer means 10, which transfers said rotation to the generator 12. It is obvious that the rotation transfer means 10 and, especially, the generator 12 are mounted at the very low positions. That drastically decreases the load moments onto/into the present wind turbine. Also that allows to perform the installation and maintenance works very simply and with low cost.

At the top part 11 of the arm 4-1 (see FIG. 4) the upper roller based component of the RS-SET is shown, it comprises (in the discussed embodiment) two rollers 5-4-1 and 5-4-2. These rollers 5-4-1 and 5-4-2 fix the rim 6 from both upward and downward shifts. Thus, the ensemble of the components of the RS-SET 5-1, . . . , 5-4 provide a fixed position (suspension) of the rotor relative the yaw-portion while the rotor has possibility to be rotated by the wind.

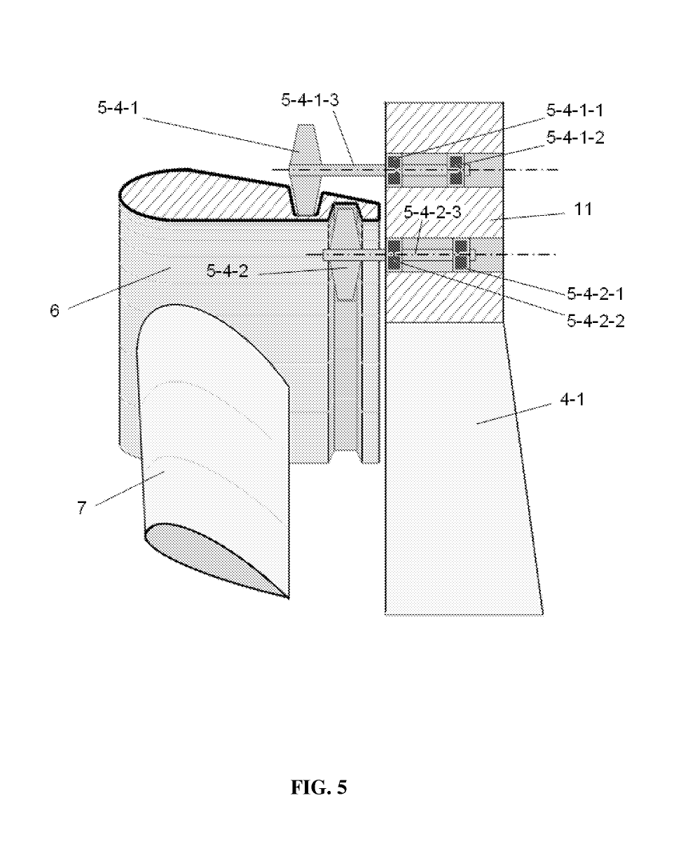

FIR.5 at a much more particular degree depicts at possible suspension of the rim 6 at the top part 11 of the arm 4-1. They are shown: the arm 4-1 having the top part 11; two rollers 5-4-1 and 5-4-2 of the upper component 5-4 (see FIGS. 1, 2, 3) of the RS-SET, said rollers 5-4-1 and 5-4-2 (see FIG. 5) are mounted onto shafts 5-4-1-3 and 5-4-2-3 accordingly; the said shafts 5-4-1-3 and 5-4-2-3 are rotatable supported by the bearings 5-4-1-1, 5-4-1-2, 5-4-2-1, and 5-4-2-2 accordingly. Two rollers 5-4-1 and 5-4-2 are fixing the rim 6 from up- and down- and for- and backward shifts since said rollers 5-4-1 and 5-4-2 are rotary passing through the upper and inner paths (not signed individually) provided onto the rim 6.

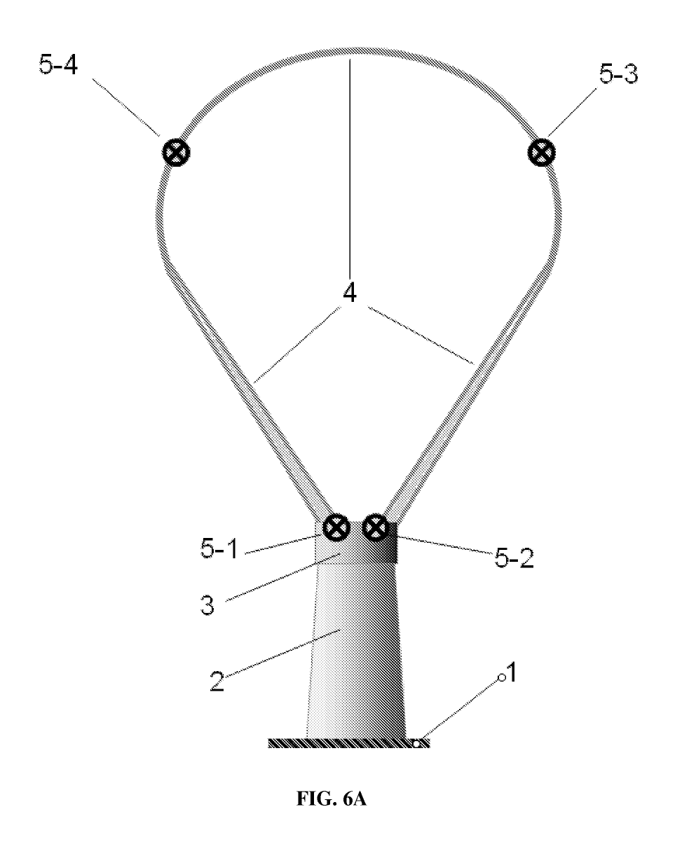

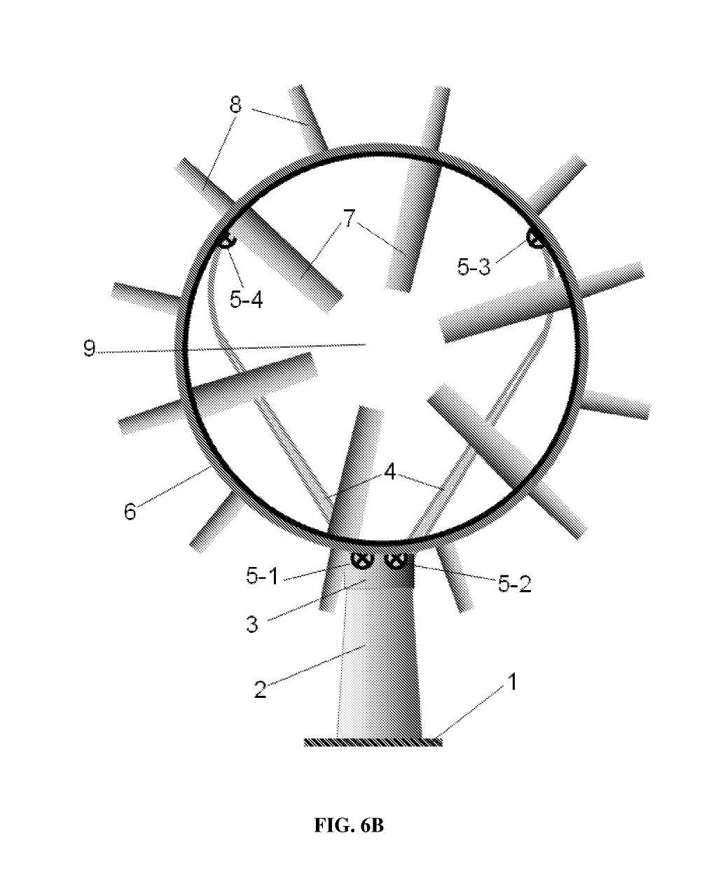

FIGS. 6A and 6B illustrate another possible shape of the yaw-portion—the single arm with pear-like shape. This arm 4 (see FIG. 6A) provides the similar positions of the upper roller based components 5-3 and 5-4 of the RS-SET. The pear-like arm 4 may be used if additional strength and rigidity are necessary. FIG. 6B represents the view of the wind turbine with said pear-like shape arm 4 (the signs are analogous to noted above FIGS. 1, 2, 3).

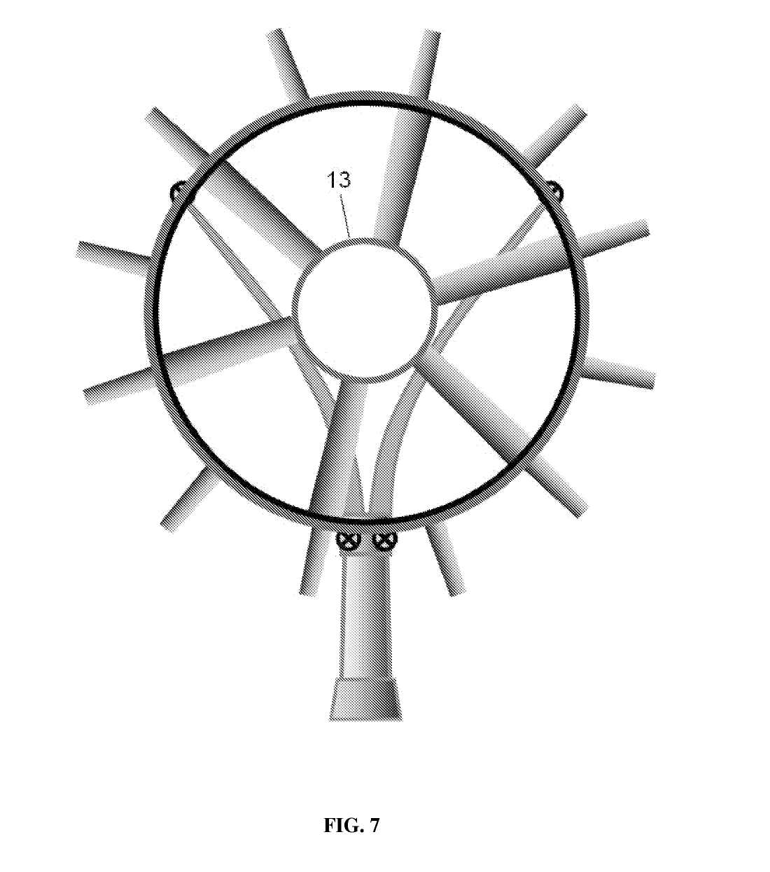

FIG. 7 depicts one of possible variants of the rotor's configuration—the rotor with central additional rim 13. This additional central rim 13 increases effect of diffuser and increases the aerodynamic efficiency of the rotor.

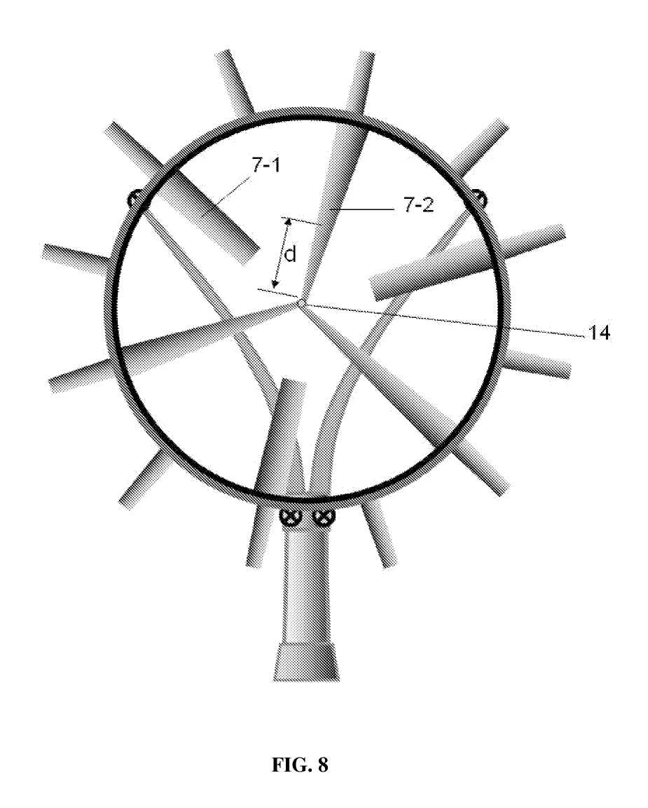

FIG. 8 depicts another possible variant of the rotor's configuration—the rotor with two ensembles of the inner-blades 7-1 and 7-2, where blades from the ensemble 7-2 have the length substantially equal to the radius of the rim and attached one with another through a central spindle 14. The spindle 14 has small dimensions and does not affect onto the diffuser passes of the air flows in the pivotal area. The tips of the blades 7-2 in the diffuser zone, singed with char “d” have a null angle-of-attack relative the air flows into the pivotal zone and do not affect onto the diffuser effect in this zone too. Such rotor's configuration may be used for increasing the rigidity of the rotor.

To suspend the rotor in the RS-SET may by used the magnet effects based components providing the support forces between rim 6 and one or more components of the RS-SET. The magnet forces may be provided by permanent or/and by electro-magnet means. The magnet suspense is preferably to combine with mechanical, generally roller based suspense components. Such suspense may significantly decrease the friction between rim and components of the RS-SET.

Small embodiments of the present turbine may be equipped with a vane attached to the yaw-portion and configured to orient the yaw-portion accordingly the wind direction.

1. A wind turbine, comprising:
a. a rotor comprising: a rim; a plurality of outer-blades; and a plurality of inner-blades; said outer-blades mounted onto said rim in such a manner as to provide to said outer-blades to be regular arranged substantially radially outward from said rim, said inner-blades mounted onto/into said rim in such a manner as to provide to said inner-blades to be regular arranged substantially radially inward from said rim;
b. a tower comprising: a standing-portion; a yaw-portion; and a turning supporting yaw-mechanism mounted on the top of said standing-portion and configured to rotatable support said yaw-portion; said yaw-portion comprising: a root-part jointed to said yaw-mechanism; and one or more arms mounted onto said root-part;
c. one or more a generator-means;
d. a rotor suspend set (RSS) mounted onto/into said yaw-mechanism or/and said root-part or/and said arm(s) and being in mechanical contact or/and magnet interaction with said rim; and
e. one or more a rotation transfer means (RTM) mounted onto/into said yaw-mechanism or/and said root-part or/and said arm(s) or/and said RSS, said RTM(s) attached to said generator-means and configured to transfer the rotatable energy to said generator-means;
wherein said yaw-mechanism or/and said root-part or/and said arm(s) or/and said RSS or/and said rim are configured so that said rim is suspended or/and supported by said RSS at at least three suspend-point(s) at a defined rotatable suspension relatively said yaw-portion with the rotor rotational axis oriented in the interval (−15°, +15°) relatively the horizontal plane;
wherein said rim or/and said RSS are configured so that said RSS provide(s) said rotor a possibility to be rotated by the wind with said rotor rotational axis and that said RSS capture(s) the rotor rotational energy of said rotor from said rim in one or more point(s) of said mechanical contact(s) and transfer(s) said rotor rotational energy to said RTM(s);
wherein said yaw-mechanism is configured to provide said yaw-portion at substantially vertical axis turning relative said standing-portion, and, optionally, to define the orientation of said yaw-portion relative the wind direction; and
wherein said rim or/and said RSS are arranged and configured so that: at least one said support-point is located at the level(s) being not higher than the level equal (LCENT−0.4*R); or/and at least three said support-points are located one from another at distances more than (0.6*R), where said LCENT is the level of the center of said rotor, said R is the radius of said rim.

2. The wind turbine of claim 1, further comprising a plurality of second-inner-blades; wherein said second-inner-blades mounted onto said rim in such a manner as to provide to said second-inner-blades to be regular arranged substantially radially inward from said rim and alternately with said inner-blades.

3. The wind turbine of claim 1, further comprising a plurality of supporting rotatable outer-posts; or/and a plurality of supporting rotatable inner-posts; said outer-posts or/and said inner-posts mounted onto/into said rim, said outer-blades mounted onto said outer-posts, said inner-blades or/and said second-inner-blades mounted onto said inner-posts; said outer-posts configured to support said outer-blades in such a manner as to provide to said outer-blades to be regular arranged substantially radially outward from said rim, said inner-posts configured to support said inner-blades or/and said second-inner-blades in such a manner as to provide to said inner-blades or/and said second-inner-blades to be regular arranged substantially radially inward from said rim; wherein, optionally, said second-inner-blades are regular arranged alternately with said inner-blades.

4. The wind turbine of claim 2, wherein the quantity of said second-inner-blades is equal (N/4) or (N/3) or (N/2) or (N) or (2*N) or (3*N) or (4*N), where said N is the quantity of said inner-blades.

5. The wind turbine of claim 2, wherein the length of said second-inner-blade is substantially equal said R, and the tips of said second-inner-blades are jointed one with another substantially in zone of location of the rotational axis of said rim.

6. The wind turbine of claim 5, wherein said second-inner-blades are configured to produce minimal drag forces at pivotal zones of said rotor, said pivotal zone is the part of said second-inner-blade with length at least (0.15*R) from said jointed tips of said second-inner-blade.

7. The wind turbine of claim 5, further comprising a spindle, wherein the tips of said second-inner-blades are fixedly or/and rotatable or/and flexible attached to said spindle; and wherein said spindle is suspended onto said tips of said second-inner-blades substantially at the center of said rim.

8. The wind turbine of claim 1, further comprising an inner-rim attached to the tips or/and the top part of said inner-blades or of said second-inner-blades and concentrically located into said rim, wherein said inner-rim is, optionally, an aerofoil diffuser configured to accelerate the pivotal air streams.

9. The wind turbine of claim 1, further comprising a plurality of spokes, wherein one end(s) of said spokes are fixedly or/and rotatable or/and flexible and regularly attached to said spindle or to said inner-rim or to opposite inner-blade or to opposite second-inner-blade or to said rim; and wherein another end(s) of said spokes are fixedly or/and rotatable or/and flexible and regularly attached to said rim or/and to the tips or/and the top part of at least part of said inner-blades or said second-inner-blades.

10. (canceled)

11. The wind turbine of claim 1, wherein said rotor suspend set (RSS) is configured to suspend or/and to supports said rim at said suspend-point(s) through support mechanical contact(s) said RSS with said rim or/and through support magnet interacting(s) said RSS with said rim.

12. The wind turbine of claim 1, wherein said rotation transfer means (RTM) is attached to said rotor suspend set (RSS) and is configured to transfer the rotational energy from said RSS to one or more said generator-means.

13. The wind turbine of claim 1, wherein one or more said arms are mounted substantially in or/and parallel to a sagittal-plane of said yaw-portion.

14. The wind turbine of claim 13, wherein said sagittal-plane of said yaw-portion is the substantially vertical plane passing through at least three said suspend-point(s) or through said arm(s) and said standing-portion.

15. The wind turbine of claim 1, wherein, optionally, one said arms has substantially a circular- or/and an arc- or/and a pear-like- or/and a triangle-shape formed or/and configured to carry at least part of said rotor suspend set (RSS) such that being mounted on said arm said at least part of said RSS provides at least two said suspend-points.

16. The wind turbine of claim 1, wherein, optionally, one said arm is extending upward and/or left-ward relatively a longitudinal-plane of said yaw-portion and another said arm is extending upward and/or right-ward relatively said longitudinal plane.

17. The wind turbine of claim 16, wherein said longitudinal-plane of said yaw-portion is the substantially vertical plane passing through said standing-portion substantially perpendicular to said sagittal-plane.

18. The wind turbine of claim 1, wherein said yaw-portion or/and said rotor are configured to provide upwind and/or downwind mode of the performance of said wind turbine.

19. The wind turbine of claim 1, further comprising one or more hard or/and flexible link(s), wherein two or more said arms are one with another coupled at middle or/and at top parts of said arms with said link(s) configured to increase the strength of said yaw-portion and the determinancy of the location or/and the reliability of the construction of said yaw-portion.

20-21. (canceled)

22. The wind turbine of claim 1, wherein said arm(s) or/and said root-part have an aerodynamic aerofoil streamline shape(s) relative wind flows passing substantially through said longitudinal-plane.

23. The wind turbine of claim 1, further comprising one or more vane means attached to said root-part or/and said yaw-mechanism or/and said arm(s) and configured to turn said yaw-portion about said vertical axis through interacting with the wind flows to define said orientation of said yaw-portion relative said wind direction.
